(19) United States
(12) Patent Application Publication
(10) Pub. No.: US 2016/0123622 A1
(43) Pub. Date: May 5, 2016

(54) AIR PURIFICATION NOTIFICATION METHOD AND APPARATUS, USER EQUIPMENT AND SYSTEM

(71) Applicant: Xiaomi Inc., Beijing (CN)

(72) Inventors: Qiang FU, Beijing (CN); Bin ZHANG, Beijing (CN); Yunlin HU, Beijing (CN)

(73) Assignee: Xiaomi Inc.

(21) Appl. No.: 14/823,411

(22) Filed: Aug. 11, 2015

Related U.S. Application Data
(63) Continuation of application No. PCT/CN2015/075022, filed on Mar. 25, 2015.

(30) Foreign Application Priority Data
Oct. 29, 2014 (CN) 201410594608.1

(51) Int. Cl. F24F 11/00; G08B 21/18; G01N 1/22

(52) U.S. Cl. CPC F24F 11/0017; G01N 1/2273; G08B 21/18

(57) ABSTRACT

An air purification notification method includes acquiring air quality data and determining whether to initiate a notification according to the air quality data. The air quality data includes at least one of inside air quality data indicating an inside air quality inside a purifying space where an air purifier is placed or outside air quality data indicating an outside air quality outside the purifying space.

### CROSS REFERENCE TO RELATED APPLICATIONS

This application is a Continuation of International Application No. PCT/CN2015/075022 with an international filing date of Mar. 25, 2015, which is based upon and claims priority to Chinese Patent Application No. 201410594608.1, filed on Oct. 29, 2014, the entire contents of both of which are incorporated herein by reference.

### TECHNICAL FIELD

The present disclosure relates to a notification method and apparatus, a user device, and a system, for air purification and, more particularly, to such a notification method and apparatus, a user device, and a system, for air purification, which determine a corresponding notification type according to air quality data inside and outside a space in which an air purifier is placed.

### BACKGROUND

Air purifiers are electrical appliances for air purification, which are nowadays more widely used indoors.

### SUMMARY

In accordance with the present disclosure, there is provided an air purification notification method. The method includes acquiring air quality data and determining whether to initiate a notification according to the air quality data. The air quality data includes at least one of inside air quality data indicating an inside air quality inside a purifying space where an air purifier is placed or outside air quality data indicating an outside air quality outside the purifying space.

Also in accordance with the present disclosure, there is provided an air purification notification apparatus. The apparatus includes one or more processors and a non-transitory computer-readable storage medium storing instructions. The instructions, when executed by the one or more processors, cause the one or more processors to acquire air quality data and determine whether to initiate a notification according to the air quality data. The air quality data includes at least one of inside air quality data indicating an inside air quality inside a purifying space where an air purifier is placed or outside air quality data indicating an outside air quality outside the purifying space.

Also in accordance with the present disclosure, there is provided a non-transitory computer-readable storage medium having stored therein instructions. The instructions, when executed by one or more processors of an apparatus, cause the apparatus to acquire air quality data and determine whether to initiate a notification according to the air quality data. The air quality data includes at least one of inside air quality data indicating an inside air quality inside a purifying space where an air purifier is placed or outside air quality data indicating an outside air quality outside the purifying space.

It shall be appreciated that the above general description and the detailed description hereinafter are only illustrative and interpretative, but not for limiting the present disclosure.

### BRIEF DESCRIPTION OF THE DRAWINGS

The accompanying drawings herein, which are incorporated into and constitute a part of the specification, illustrate embodiments consistent with the present disclosure, and together with the description, serve to explain the principles of the present disclosure.

FIG. 1 is a flowchart illustrating an air purification notification method according to an exemplary embodiment of the present disclosure.

FIG. 2 is a block diagram illustrating an air purification notification apparatus according to an exemplary embodiment of the present disclosure.

FIG. 3 is a block diagram illustrating an air purification system according to an exemplary embodiment of the present disclosure.

FIG. 4 is a block diagram illustrating an apparatus for performing air purification notification methods according to an exemplary embodiment of the present disclosure.

FIG. 5 is a block diagram illustrating an apparatus for performing air purification notification methods according to another exemplary embodiment of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

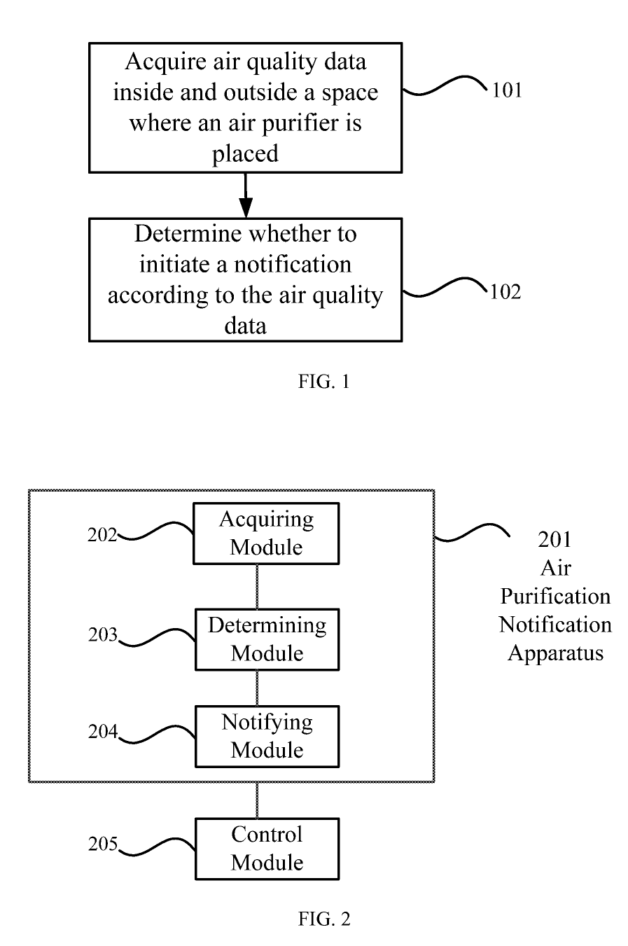

FIG. 1 is a flowchart illustrating an air purification notification method according to an exemplary embodiment of the present disclosure. As illustrated in FIG. 1, at 101, air quality data is acquired. The air quality data includes at least one of air quality data inside a space where an air purifier is placed (hereinafter also referred to as “purifying space”) or air quality data outside the purifying space. At 102, whether to initiate a notification is determined according to the air quality data.

According to the present disclosure, various notifications can be initiated depending on the air quality data. For example, if the air quality data indicates that the air quality outside the purifying space is better than the air quality inside the purifying space, and that the air quality outside the purifying space is better than a predetermined value, and if the air purifier is turned on, then it is determined that a first type notification needs to be initiated. On the other hand, if the air quality data indicates that the air quality inside the purifying space is poorer than a predetermined value and if the air purifier is turned off, then it is determined that a second type notification needs to be initiated. Further, if, after the air purifier is started and has run for a predetermined time period, the air quality data indicates that the air quality inside the purifying space is still poorer than a predetermined value, it is determined that a third type notification needs to be initiated.

In some embodiments, the air quality data regarding the air quality inside the purifying space and that outside the purifying space can both be acquired via air quality sensors. In some embodiments, the air quality data regarding the air quality outside the purifying space can be acquired in real time over the Internet, and the air quality data regarding the air quality inside the purifying space via an air quality sensor.

In some embodiments, the air purification notification method further includes sending corresponding notification information when it is determined that a notification is needed. The notification information may include a change in the color of the user interface, an image notification, a text notification, a sound notification, or the like.

In some embodiments, the air purification notification method further includes performing, by a user, any one or more of the following control operations according to the notification information: controlling On/Off of the air purifier, adjusting an operation state of the air purifier, and controlling opening and closing of windows in a room.

In some embodiments, the notification may be initiated once within one day, multiple times within one day, zero times within one day, and/or zero times within a specified time period (for example, a time period from 22:00 to 8:00).

In some embodiments, air purification notification methods according to the present disclosure, such as those described above, can be performed by a user device, which may include any one or more of the following: a mobile phone, a computer, a digital broadcast terminal, a messaging device, a gaming console, a tablet, a medical device, an exercise device, a personal digital assistant, and the like.

In some embodiments, the air purifier is placed in a room, in a house, in a corridor, in a car, or in any place where air purification is needed. In some embodiments, the user device may be connected, in a wired manner or a wireless manner, to the air purifier and/or doors and/or windows of the purifying space.

For example, the air purifier is placed indoors, and the user device acquires outdoor and indoor air quality data. If the air quality data indicates that the outdoor air quality is better than the indoor air quality, and that the outdoor air quality is better than a predetermined value (for example, when an outdoor air quality index is lower than 30, it is considered that the outdoor air quality is better than the predetermined value), and if the air purifier is turned on, then the user device determines that there is a need to initiate the first type notification (also referred to as a “blue sky notification”). In this case, the user device may prompt the user to turn off the air purifier and open the doors and/or windows, via a change of the color of the user interface, an image-text notification, a sound notification, or the like.

As another example, the air purifier is placed indoors, and the user device acquires the indoor air quality data. If the air quality data indicates that the indoor air quality is poorer than a predetermined value (for example, when an indoor air quality index is higher than a preset value, it is considered that the indoor air quality is poorer than the predetermined value), and if the air purifier is turned off, then the user device determines that there is a need to initiate the second type notification (also referred to as a “pollution notification”). In this case, the user device may prompt the user to turn on the air purifier and close the doors and windows, via a change of the color of the user interface, an image-text notification, a sound notification, or the like.

As another example, the air purifier is placed indoors, and the user device acquires the indoor air quality data. If, after the air purifier is started and has run for a predetermined time period (for example, 1 hour), the air quality data indicates that the indoor air quality is still poorer than a predetermined value (for example, the indoor air quality index is higher than a preset value), then it is considered that the air purifier is malfunctioning or the air purifier is not effective because the door and/or the window is not closed, and thus the user device determines that there is a need to initiate the third type notification (also referred to as a “abnormal operation notification”). In this case, the user equipment may prompt the user to check the states of the air purifier and the doors and windows, via a change of the color of the user interface, an image-text notification, a sound notification, or the like.

FIG. 2 is a block diagram illustrating an air purification notification apparatus 201 according to an exemplary embodiment of the present disclosure. As shown in FIG. 2, the air purification notification apparatus 201 includes an acquiring module 202, a determining module 203, and a notifying module 204.

The acquiring module 202 is configured to acquire air quality data. The air quality data includes at least one of air quality data inside a space where an air purifier is placed (the purifying space) or air quality data outside the purifying space. The determining module 203 is configured to determine whether to initiate a notification according to the air quality data.

According to the present disclosure, various notifications can be initiated depending on the air quality data. For example, if the air quality data indicates that the air quality outside the purifying space is better than the air quality inside the purifying space, and that the air quality outside the purifying space is better than a predetermined value, and if the air purifier is turned on, then the determining module 203 determines that a first type notification needs to be initiated. On the other hand, if the air quality data indicates that the air quality inside the purifying space is poorer than a predetermined value and if the air purifier is turned off, then the determining module 203 determines that a second type notification needs to be initiated. Further, if, after the air purifier is started and has run for a predetermined time period, the air quality data indicates that the air quality inside the purifying space is still poorer than a predetermined value, then the determining module 203 determines that a third type notification needs to be initiated.

In some embodiments, the acquiring module 202 acquires the air quality data regarding the air quality inside the purifying space and the air quality data regarding the air quality outside the purifying space via air quality sensors. In some embodiments, the acquiring module 202 acquires the air quality data regarding the air quality outside the purifying space in real time over the Internet, and acquires the air quality data regarding the air quality inside the purifying space via an air quality sensor.

In some embodiments, as shown in FIG. 2, the air purification notification apparatus 201 further includes the notifying module 204, configured to send corresponding notification information when it is determined that a notification is needed.

In some embodiments, as shown in FIG. 2, the air purification notification apparatus 201 is connected to a control module 205. The control module 205 is configured to perform any one or more of the following control operations according to an instruction of a user: controlling On/Off of the air purifier, adjusting an operation state of the air purifier, and controlling opening and closing of doors and windows in the purifying space.

In some embodiments, the air purification notification apparatus 201 is configured to initiate one notification within one day or multiple notifications within one day, not initiate any notification within one day, and/or not initiate any notification within a specified time period (for example, a time period from 22:00 to 8:00).

In some embodiments, the air purification notification apparatus 201 can be installed in a user device, which may include one or more of the following: a mobile phone, a computer, a digital broadcast terminal, a messaging device, a gaming console, a tablet, a medical device, an exercise device, a personal digital assistant, and the like. In some embodiments, the control module 205 is also installed in the user device.

In some embodiments, the user device may be connected, in a wired manner or wireless manner, to the air purifier and/or doors and windows of the purifying space.

For example, the air purifier is placed indoors, and the acquiring module 202 acquires outdoor and indoor air quality data. If the air quality data indicates that the outdoor air quality is better than the indoor air quality, and that the outdoor air quality is better than a predetermined value (for example, when an outdoor air quality index is lower than 30, it is considered that the outdoor air quality is better than the predetermined value), and if the air purifier is turned on, then the determining module 203 determines that there is a need to initiate the first type notification (also referred to as a “blue sky notification”). In this case, the notifying module 204 may prompt the user to turn off the air purifier and open the doors and windows, via a change of the color of the user interface, an image-text notification, a sound notification, or the like.

As another example, the air purifier is placed indoors, and the acquiring module 202 acquires the indoor air quality data. If the air quality data indicates that the indoor air quality is poorer than a predetermined value (for example, when an indoor air quality index is higher than a preset value, it is considered that the indoor air quality is poorer than the predetermined value), and if the air purifier is turned off, then the determining module 203 determines that there is a need to initiate the second type notification (also referred to as a “pollution notification”). In this case, the notifying module 204 may prompt the user to turn on the air purifier and close the doors and windows, via a change of the color of the user interface, an image-text notification, a sound notification, or the like.

As another example, the air purifier is placed indoors, and the acquiring module 202 acquires the indoor air quality data. If, after the air purifier is started and has run for a predetermined time period (for example, 1 hour), the air quality data indicates that the indoor air quality is still poorer than a predetermined value (for example, the indoor air quality index is higher than a preset value), then it is considered that the air purifier is malfunctioning or the air purifier is not effective because the door and/or the window is not closed, and thus the determining module 203 determines that there is a need to initiate the third type notification (also referred to as a “abnormal operation notification”). In this case, the notifying module 204 may prompt the user to check the states of the air purifier and the doors and windows, via a change of the color of the user interface, an image-text notification, a sound notification, or the like.

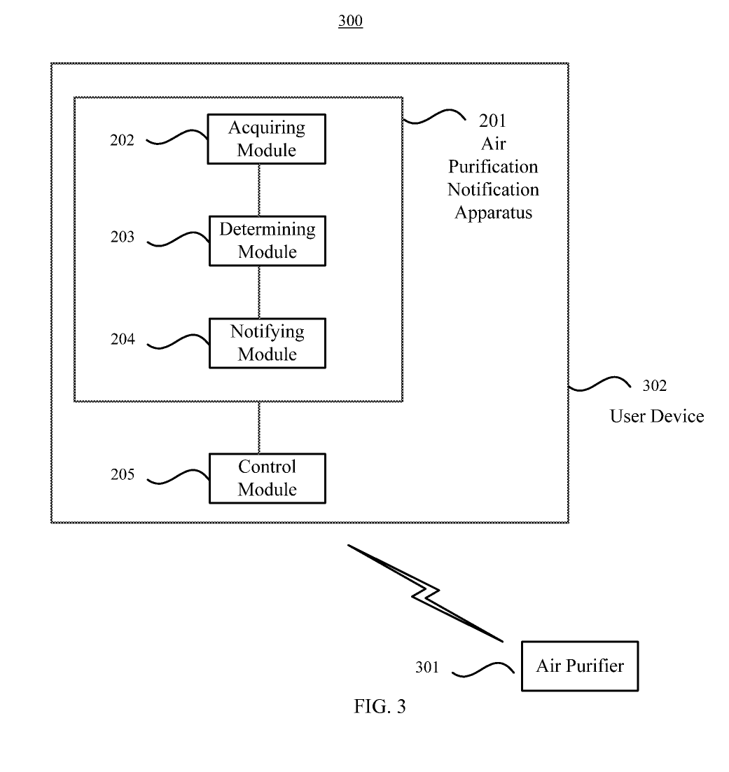

FIG. 3 is a block diagram illustrating an air purification system 300 according to an exemplary embodiment of the present disclosure. As shown in FIG. 3, the air purification system 300 includes an air purifier 301 and a user device 302. The user equipment includes the air purification notification apparatus 201 and the control module 205.

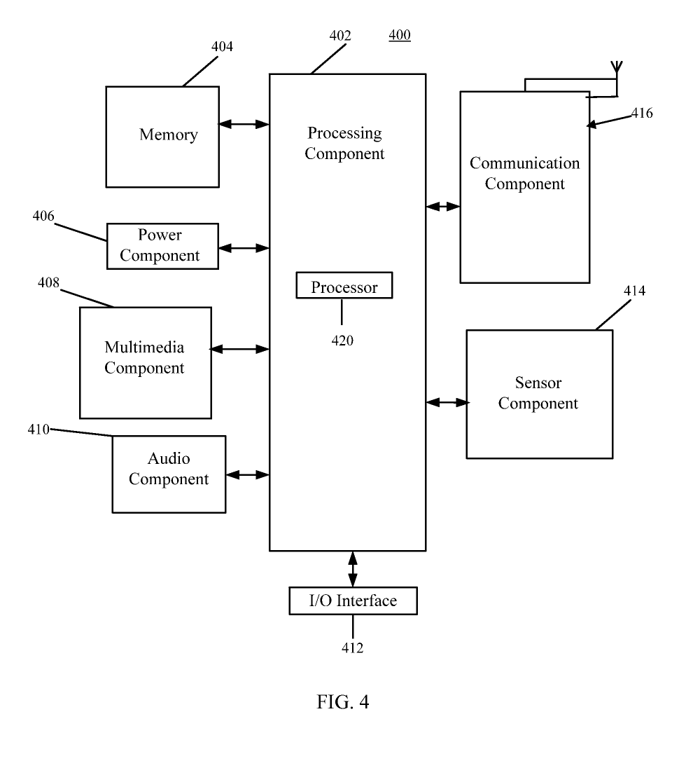

FIG. 4 is a block diagram illustrating an apparatus 400 for performing air purification notification methods according to an exemplary embodiment of the present disclosure. For example, the apparatus 400 may be a mobile phone, a computer, a digital broadcast terminal, a messaging device, a gaming console, a tablet, a medical device, an exercise equipment, a personal digital assistant, or the like.

Referring to FIG. 4, the apparatus 400 includes one or more of the following components: a processing component 402, a memory 404, a power component 406, a multimedia component 408, an audio component 410, an input/output (I/O) interface 412, a sensor component 414, and a communication component 416.

The processing component 402 typically controls overall operations of the apparatus 400, such as the operations associated with display, telephone calls, data communications, camera operations, and recording operations. The processing component 402 may include one or more processors 420 to execute instructions to perform all or a part of the steps in the above-described methods. In addition, the processing component 402 may include one or more modules which facilitate the interaction between the processing component 402 and other components. For example, the processing component 402 may include a multimedia module to facilitate the interaction between the multimedia component 408 and the processing component 402.

The memory 404 is configured to store various types of data to support the operations of the apparatus 400. Examples of such data include instructions for any application or method operated on the apparatus 400, contact data, phonebook data, messages, pictures, videos, and the like. The memory 404 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 406 provides power to various components of the apparatus 400. The power component 406 may include a power management system, one or more power supplies, and other components associated with the generation, management, and distribution of power in the apparatus 400.

The multimedia component 408 includes a screen providing an output interface between the apparatus 400 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 408 includes a front camera or/and a rear camera. The front camera and/or the rear camera may receive external multimedia data when the apparatus 400 is in an operation mode, such as a photographing mode or a video mode. Each of the front camera and the rear camera may be a fixed optical lens system or have focus and optical zoom capability.

The audio component 410 is configured to output or/and input audio signals. For example, the audio component 410 includes a microphone configured to receive an external audio signal when the apparatus 400 is in an operation mode, such as a call mode, a recording mode, or a voice recognition mode. The received audio signal may be further stored in the memory 404 or transmitted via the communication component 416. In some embodiments, the audio component 410 further includes a speaker to output audio signals.

The I/O interface 412 provides an interface between the processing component 402 and a peripheral interface module, such as a keyboard, a click wheel, a button, or the like. The buttons may include, but are not limited to, a home button, a volume button, a starting button, and a locking button.

The sensor component 414 includes one or more sensors to provide status assessments of various aspects of the apparatus 400. For example, the sensor component 414 may detect an open/closed status of the apparatus 400, relative positioning of components, e.g., the display and the keypad, of the apparatus 400, a change in position of the apparatus 400 or a component of the apparatus 400, a presence or absence of user contact with the apparatus 400, an orientation or an acceleration/deceleration of the apparatus 400, and a change in temperature of the apparatus 400. The sensor component 414 may include a proximity sensor configured to detect the presence of nearby objects without any physical contact. The sensor component 414 may also include a light sensor, such as a CMOS or CCD image sensor, for use in imaging applications. In some embodiments, the sensor component 414 may also include an accelerometer sensor, a gyroscope sensor, a magnetic sensor, a pressure sensor, or a temperature sensor.

The communication component 416 is configured to facilitate communications, wired or wirelessly, between the apparatus 400 and other devices. The apparatus 400 may access a wireless network based on a communication standard, such as WiFi, 2G, 3G, or 4G, or a combination thereof. In one exemplary embodiment, the communication component 416 receives a broadcast signal or broadcast associated information from an external broadcast management system via a broadcast channel. In one exemplary embodiment, the communication component 416 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 400 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above-described methods.

In exemplary embodiments, there is also provided a non-transitory computer-readable storage medium, such as included in the memory 404, storing instructions executable by the processor 420 in the apparatus 400, for performing methods consistent with embodiments of the present disclosure. For example, the non-transitory computer-readable storage medium may be a ROM, a random access memory (RAM), a compact disc read-only memory (CD-ROM), a magnetic tape, a floppy disc, an optical data storage device, or the like.

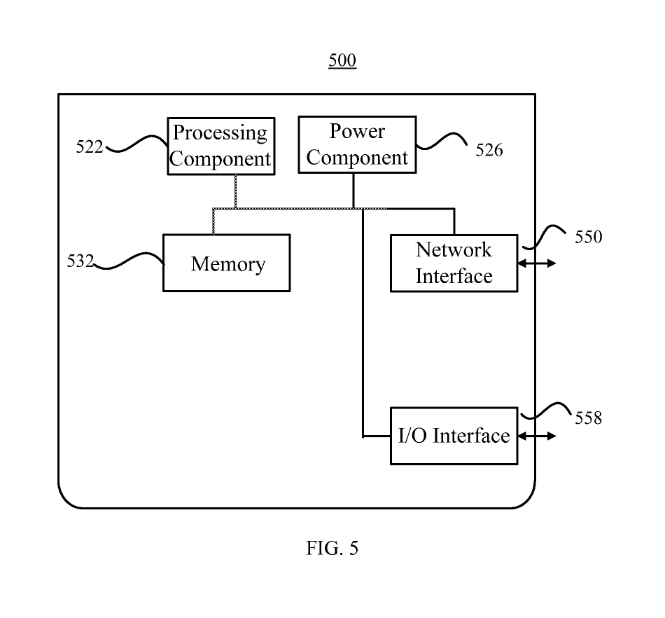

FIG. 5 is a block diagram illustrating an apparatus 500 for performing air purification notification methods according to an exemplary embodiment of the present disclosure. For example, the apparatus 500 may be provided as a server. As shown in FIG. 5, the apparatus 500 includes a processing component 522, which further includes one or more processors; and memory resources represented by a memory 532, configured to store instructions executable by the processing component 522, for example, applications. The applications stored in the memory 532 may include one or more than one module each corresponding to a group of instructions. In addition, the processing component 522 is configured to execute the instructions to perform air purification notification methods consistent with embodiments of the present disclosure.

In some embodiments, as shown in FIG. 5, the apparatus 500 further includes a power component 526, configured to perform power management in the apparatus 500; a wired or wireless network interface 550, configured to connect the apparatus 500 to a network; and an input/output (I/O) interface 558. The apparatus 500 may operate an operating system stored in the memory 532, for example, Windows Server™, Mac OS X™, Unix™, Linux™, FreeBSD™, or the like.

Other embodiments of the present disclosure will be apparent to those skilled in the art from consideration of the specification and practice disclosed herein. This application is intended to cover any variations, uses, or adaptations of the present disclosure following the general principles thereof and including such departures from the present disclosure as coming within common knowledge or customary technical means in the art. It is intended that the specification and embodiments be considered as exemplary only, with a true scope and spirit of the present disclosure being indicated by the appended claims.

It will be appreciated that the present disclosure is not limited to the exact construction that has been described above and illustrated in the accompanying drawings, and that various modifications and changes can be made without departing from the scope thereof. The scope of the present disclosure is only defined by the appended claims.

What is claimed is:

1. An air purification notification method, comprising:
acquiring air quality data, the air quality data including at least one of:
inside air quality data indicating an inside air quality inside a purifying space where an air purifier is placed, or
outside air quality data indicating an outside air quality outside the purifying space; and
determining, according to the air quality data, whether to initiate a notification.

2. The method according to claim 1, wherein determining whether to initiate the notification includes determining if:
the air quality data indicates that the outside air quality is better than the inside air quality and the outside air quality is better than a predetermined value, and
the air purifier is turned on.

3. The method according to claim 1, wherein determining whether to initiate the notification includes determining if:
the air quality data indicates that inside air quality is poorer than a predetermined value, and
the air purifier is turned off.

4. The method according to claim 1, wherein determining whether to initiate the notification includes determining if, after the air purifier is started and has run for a predetermined time period, the air quality data indicates that the inside air quality is still poorer than a predetermined value.

5. The method according to claim 1, wherein acquiring the air quality data includes at least one of:
acquiring the inside air quality data and the outside air quality data via at least one air quality sensor; or
acquiring the outside air quality data in real time over the Internet, and acquiring the inside air quality data via an air quality sensor.

6. The method according to claim 1, further comprising:
sending corresponding notification information when it is determined to initiate the notification.

7. The method according to claim 6, further comprising:
selecting, by a user, one or more control operations according to the notification information, including: controlling On/Off of the air purifier, adjusting an operation state of the air purifier, and controlling opening and closing of a window in a room.

8. The method according to claim 1, wherein determining whether to initiate the notification includes:
determining to initiate one notification within one day,
determining to initiate multiple notifications within one day,
determining to not initiate the notification within one day, or
determining to not initiate the notification within a specified time period.

9. An air purification notification apparatus, comprising:
one or more processors; and
a non-transitory computer-readable storage medium storing instructions that, when executed by the one or more processors, cause the one or more processors to:
acquire air quality data, the air quality data including at least one of:
inside air quality data indicating an inside air quality inside a purifying space where an air purifier is placed, or
outside air quality data indicating an outside air quality outside the purifying space; and
determine, according to the air quality data, whether to initiate a notification.

10. The apparatus according to claim 9, wherein the instructions further cause the one or more processors to determine to initiate the notification if:
the air quality data indicates that the outside air quality is better than the inside air quality and the outside air quality is better than a predetermined value, and
the air purifier is turned on.

11. The apparatus according to claim 9, wherein the instructions further cause the one or more processors to determine to initiate the notification if:
the air quality data indicates that inside air quality is poorer than a predetermined value, and
the air purifier is turned off.

12. The apparatus according to claim 9, wherein the instructions further cause the one or more processors to determine to initiate the notification if, after the air purifier is started and has run for a predetermined time period, the air quality data indicates that the inside air quality is still poorer than a predetermined value.

13. The apparatus according to claim 9, wherein the instructions further cause the one or more processors to:
acquire the inside air quality data and the outside air quality data via at least one air quality sensor; or
acquire the outside air quality data in real time over the Internet, and acquire the inside air quality data via an air quality sensor.

14. The apparatus according to claim 9, wherein the instructions further cause the one or more processors to:
send corresponding notification information when it is determined to initiate the notification.

15. The apparatus according to claim 9, wherein the instructions further cause the one or more processors to:
determine to initiate one notification within one day,
determine to initiate multiple notifications within one day,
determine to not initiate the notification within one day, or
determine to not initiate the notification within a specified time period.

16. The apparatus according to claim 9, wherein the instructions further cause the one or more processors to:
receive a selection of one or more control operations including: controlling On/Off of the air purifier, adjusting an operation state of the air purifier, and controlling opening and closing of a window in a room.

17. A non-transitory computer-readable storage medium having stored therein instructions that, when executed by one or more processors of an apparatus, cause the apparatus to:
acquire air quality data, the air quality data including at least one of:
inside air quality data indicating an inside air quality inside a purifying space where an air purifier is placed, or
outside air quality data indicating an outside air quality outside the purifying space; and
determine, according to the air quality data, whether to initiate a notification.
